(19) United States
(12) Patent Application Publication
(10) Pub. No.: US 2011/0214899 A1
(43) Pub. Date: Sep. 8, 2011

(54) INSULATION RESIN COMPOSITION RESISTANT TO THERMAL DEFORMATION AND CABLE USING THE SAME

(75) Inventors: Min-Su JUNG, Anyang-si (KR); Jin-Ho Nam, Namyangju-si (KR); Ung Kim, Gunpo-si (KR)

(73) Assignee: LS Cable Ltd., Anyang-City (KR)

(21) Appl. No.: 12/874,431

(22) Filed: Sep. 2, 2010

(30) Foreign Application Priority Data
Mar. 3, 2010 (KR) 10-2010-0019084

(51) Int. Cl. H01B 7/00; C08L 23/08; H01B 3/30

(52) U.S. Cl. 174/113 C; 525/387; 174/110 SR

(57) ABSTRACT

Disclosed is an insulation resin composition resistant to thermal deformation comprising an ethylene copolymer base resin having crystallinity between 1% and 30%, not including 30%; and 0.5 to 20 parts by weight of an organic peroxide-based crosslinking agent per 100 parts by weight of the base resin, and a cable using the same. The insulation is resistant to thermal deformation that may occur after a crosslinking process under high temperature and high pressure subsequently to extrusion of a sheath.

### CROSS-REFERENCE TO RELATED APPLICATION(S)

This application claims priority to Korean Patent Application No. 10-2010-0019084, filed on Mar. 3, 2010, in Republic of Korea, the entire disclosure of which is incorporated herein by reference for all purposes.

### BACKGROUND

1. Field

The following disclosure relates to an insulation resin composition resistant to thermal deformation and a cable using the same.

2. Description of the Related Art

Conventionally, low-density polyethylene or linear low-density polyethylene was mainly used as a crystalline resin that meets the electrical properties such as insulation resistivity and voltage withstand, as well as the mechanical properties. However, in the cable manufactured by assembly of insulating electric wires formed using such crystalline resin, when a sheath is crosslinked under a steam atmosphere of high temperature and high pressure (for example, temperature of 180° C. and pressure of 8 bar), an insulator may be deformed or melted. If deformation occurs to an insulator, the insulator does not maintain its original appearance basically required therefor. As a result, it may cause a quality degradation problem to the basic appearance of the cable. Furthermore, it is impossible to ensure the electrical properties, i.e., the most important properties of the insulator, for example insulation resistivity and voltage withstand, and thus, in the case that electricity of high voltage is used, dielectric breakdown may occur.

To solve the problem, the related industry has used resin of high crystallinity, and devised a scheme for crosslinking a sheath in a batch manner, not by continuous vulcanization. However, if crosslinking is made in such a batch manner, the crosslinking should be made for a very long time at such a low temperature that thermal deformation of an insulator does not occur, resulting in reduction in productivity.

Therefore, there is an urgent need for development of an insulation resin composition capable of improving productivity of an insulator while preventing thermal deformation of the insulator.

### SUMMARY

In one general aspect, there is provided a An insulation resin composition resistant to thermal deformation, including: a base resin including an ethylene copolymer having crystallinity less than 30%, and 0.5 to 20 parts by weight of an organic peroxide-based crosslinking agent per 100 parts by weight of the base resin.

In the insulation resin composition resistant to thermal deformation, the base resin may include an ethylene copolymer having crystallinity between 1% and 30%, not including 30%.

An insulating electric wire may include a central conductor, coated with any of the above insulation resin compositions resistant to thermal deformation.

A cable may include at least one of the insulating electric wires.

The cable may further include that the insulation has a tensile strength of 12.5 N/m² or more and an elongation of 250% or more at room temperature, and a hardness of 90 or less using a Shore A hardness scale.

Other features and aspects may be apparent from the following detailed description, the drawings, and the claims.

### BRIEF DESCRIPTION OF THE DRAWINGS

FIG. 1 is a cross-sectional view of a conventional cable.

FIG. 2 is a cross-sectional view of a cable according to an embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

The insulation resin composition resistant to thermal deformation according to an embodiment comprises an ethylene copolymer base resin having crystallinity between 1% and 30%, not including 30%, and 0.5 to 20 parts by weight of an organic peroxide-based crosslinking agent per 100 parts by weight of the base resin. The insulation resin composition may include 1 to 10 parts by weight of an organic peroxide-based crosslinking agent per 100 parts by weight of an ethylene copolymer base resin having crystallinity between 1% and 30%, not including 30%.

The ethylene copolymer may be an ethylene propylene copolymer, an ethylene butene copolymer, an ethylene octene copolymer and so on, singularly or in combination thereof. If an insulator is formed from an ethylene copolymer having crystallinity less than 1%, it may be less desirable because the insulator has a low tensile strength at room temperature. If an insulator is formed from an ethylene copolymer having crystallinity of 30% or more, it may be less desirable because the insulator has a relatively high hardness at room temperature and a relatively high modulus at a low elongation. Accordingly, to overcome the drawback, embodiments use an ethylene copolymer having crystallinity between 1% and 30%, not including 30%.

Embodiments use an organic peroxide-based crosslinking agent for chemical crosslinking. The organic peroxide-based crosslinking agent may be benzoyl peroxide, 1,1-bis(t-butylperoxy)3,3,5-trimethylcyclohexane, dicumyl peroxide, t-butylperoxy benzoate, di-t-butylperoxyhexane, and so on.

For example, the content of the crosslinking agent is 0.5 to 20 parts by weight per 100 parts by weight of the base resin. If the content of the crosslinking agent is less than the minimum limit, it results in insufficient crosslinking, so that a resulting insulator has poor mechanical properties. If the content of the crosslinking agent exceeds the maximum limit, by-products of thermal reaction are generated in excess during crosslinking, so that a resulting insulator has reduction in electrical properties such as volume resistivity and mechanical properties such as elongation. Accordingly, the organic peroxide-based crosslinking agent of an embodiment may be used within the above-mentioned numeric range.

In addition to the organic peroxide-based crosslinking agent, an unsaturated organic compound having multi-functionality may be used as a crosslinking coagent to improve the crosslinking rate and crosslinking density. The crosslinking coagent may be a multi-functional acryl-based crosslinking coagent such as trimethylolpropanetrimethacrylate, a liquid polybutadiene crosslinking coagent, an allyl-based crosslinking coagent such as triallyl isocyanurate, and so on.

The insulation resin composition resistant to thermal deformation according to an embodiment may comprise typical additives having various functions other than the above-mentioned components, without impairing the effects of the embodiment. The additives include flame retardants, reinforcing agents, UV stabilizers, antioxidants, lubricants, anti-blocking agents, antistatic agents, waxes, coupling agents, paints and so on, however embodiments are not limited in this regard. Various kinds of additives may be selected according to necessity of the particular embodiment.

Also, embodiments provide an insulating electric wire comprising an insulation material prepared using the insulation resin composition. The insulating electric wire comprises a central conductor and an insulator surrounding the central conductor, and the insulator is made from an insulation material prepared using the insulation resin composition of an embodiment.

Furthermore, embodiments provide a cable comprising the insulating electric wire. The insulation has tensile strength of 12.5 N/m² or more and elongation of 250% or more at room temperature and hardness of 90 or less using Shore A hardness scale. Accordingly, the cable can be effectively used as cables for power plants or shipboard that are exposed to the external environment and thus are easy to break due to flexibility reduction resulted from frequent entanglement or disentanglement by the external environment and due to intolerance of load at high temperature.

In the manufacture of a cable using an insulation resin composition resistant to thermal deformation, although a sheath is crosslinked under a high temperature and high pressure atmosphere, thermal deformation of an insulator does not occur, thereby improving productivity of the cable.

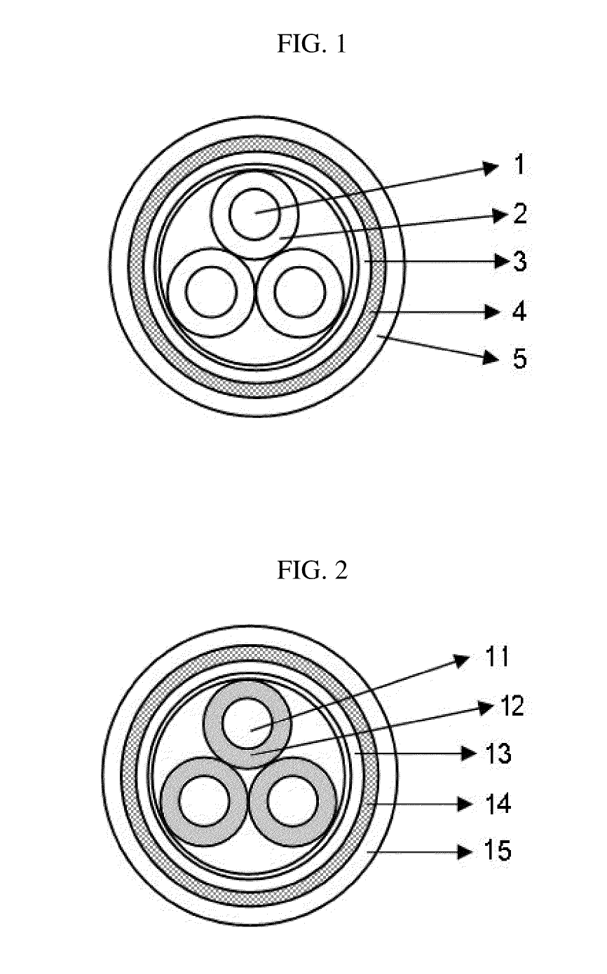

FIG. 1 is a cross-sectional view of a conventional cable for comparison with embodiments. The cable of FIG. 1 comprises a plurality of conductors 1 in the center thereof; an insulation 2 of a low-density polyethylene or linear low-density polyethylene having crystallinity of 30% or more, surrounding each conductor 1; a bedding 3 of a thermoplastic or thermosetting material, surrounding the insulation 2; a braid layer 4 of copper or tin-plated copper, surrounding the bedding 3; and a sheath 5 of a thermosetting material, surrounding the braid layer 4. According to various embodiments, the bedding 3 and the braid layer 4 may be not included in a configuration of the cable.

FIG. 2 is a cross-sectional view of a cable according to embodiments. The cable of FIG. 2 comprises a plurality of conductors 11 in the center thereof; an insulation 12 formed from the insulation resin composition containing an ethylene copolymer having crystallinity less than 30%, surrounding each conductor 11; a bedding 13 of a thermoplastic or thermosetting material, surrounding the insulation 12; a braid layer 14 of copper or tin-plated copper, surrounding the bedding 13; and a sheath 15 of a thermosetting material, surrounding the braid layer 14. According to various embodiments, the bedding 13 and the braid layer 14 may be not included in a configuration of the cable.

When a cable is manufactured using the insulation resin composition resistant to thermal deformation according to an embodiment, although a sheath is crosslinked under a high temperature and high pressure atmosphere, thermal deformation of an insulator does not occur, thereby advantageously improving productivity of the cable.

Embodiments will be described in detail through examples. The description proposed herein is just an example for the purpose of illustrations only, not intended as limiting, so it should be understood that other equivalents and modifications could be made thereto without departing from the spirit and scope of embodiments.

To find out changes in performance depending on components of an insulation resin composition having thermal resistance characteristics according to an embodiment, insulation resin compositions of examples and comparative examples were prepared according to formula of Table 1. The unit of Table 1 is parts by weight.

TABLE 1

| | Exam- | Exam- | Exam- | Exam- | Exam- | Comparative | Comparative |
|---|---|---|---|---|---|---|---|
| Components | ple 1 | ple 2 | ple 3 | ple 4 | ple 5 | example 1 | example 2 |
| Base resin a | 100 | | | | | | |
| Base resin b | | 100 | | | | | |
| Base resin c | | | 100 | | | | |
| Base resin d | | | | 100 | | | |
| Base resin e | | | | | 100 | | |
| Base resin f | | | | | | 100 | |
| Base resin g | | | | | | | 100 |
| Crosslinking | 3 | 3 | 3 | 3 | 3 | 3 | 3 |
| agent | | | | | | | |

[Description of components used in Table 1]
Base resin a: Ethylene butene copolymer having crystallinity of 1%
Base resin b: Ethylene butene copolymer having crystallinity of 4%
Base resin c: Ethylene butene copolymer having crystallinity of 10%
Base resin d: Ethylene octene copolymer having crystallinity of 16%
Base resin e: Ethylene octene copolymer having crystallinity of 21%
resin f: Ethylene butene copolymer having crystallinity of 33%
resin g: Ethylene octene copolymer having crystallinity of 37%
Crosslinking agent: dicumylperoxide

Measurement and Evaluation of Material Properties

Insulation materials were prepared using insulation resin compositions according to examples 1 to 5 and comparative examples 1 and 2, and cable specimens with insulations formed from the insulation materials were manufactured in a typical method. The structure of the cables manufactured using the insulation resin compositions of examples 1 to 5 is shown in FIG. 2, and the structure of the cables manufactured using the insulation resin compositions of comparative examples 1 and 2 is shown in FIG. 1.

The cable specimens of examples and comparative examples, obtained as mentioned above, were tested for mechanical properties, flame retardancy and appearance, and the test results are shown in Table 2. The test conditions are briefly described below.

A) Hardness

The insulation should have hardness of 90 or less using Shore A hardness scale.

B) Tensile Strength & Elongation

The insulation should have tensile strength of 12.5 N/mm² or more and elongation of 250% or more when measured at tensile speed of 250 mm/min in accordance with IEC 60811-1-1.

C) Modulus

The insulation should have modulus of 5 N/mm² or less at elongation of 3%.

D) Thermal Deformation Resistance

After a sheath was crosslinked under a high temperature (150 to 210° C.) and high pressure (6 to 20 bar) atmosphere, it evaluated how much an insulation was deformed.

E) Volume Resistivity

It measured volume resistivity at room temperature in accordance with ASTM D257. After the specimen was put aside at room temperature for 3 hours or more, the specimen was charged. At this time, direct current 500V was used as electric power. After charging for 1 minute, it measured volume resistivity at room temperature. The required volume resistivity at room temperature is 10¹⁵Ω or more.

TABLE 2

| | | Exam- | Exam- | Exam- | Exam- | Exam- | Comparative | Comparative |
|---|---|---|---|---|---|---|---|---|
| Test items | | ple 1 | ple 2 | ple 3 | ple 4 | ple 5 | example 1 | example 2 |
| Shore A hardness | | 75 | 86.2 | 87 | 76 | 88 | 96.0 | 97.8 |
| Room | Tensile | 13.1 | 18.6 | 21.6 | 15.3 | 24.5 | 18.8 | 20.5 |
| temperature | strength | | | | | | | |
| | Elongation | 560 | 538 | 472 | 450 | 500 | 424 | 485 |

| Modulus | 1.3 | 2.8 | 3.8 | 2.4 | 4.7 | 5.5 | 6.0 |
|---|---|---|---|---|---|---|---|
| Thermal deformation | No deformation | | | | | Severe deformation | |
| resistance | | | | | | | |
| Volume resistivity at | 3.52E+15 | 5.68E+15 | 1.28E+16 | 8.54E+15 | 9.19E+15 | 1.95E+16 | 9.11E+15 |
| room temperature | | | | | | | |

As shown in Table 2, the cables with the insulations formed from the insulation resin compositions of examples 1 to 5 satisfied all the standards for hardness, tensile strength and elongation, modulus and volume resistivity at room temperature, and exhibited no deformation at the thermal deformation resistance testing.

However, the cables with the insulations formed from the insulation resin compositions of comparative examples 1 and 2 did not satisfy the standards for hardness and modulus, and exhibited severe deformation at the thermal deformation resistance testing.

These results are caused by a difference in crystallinity of an ethylene copolymer. In other words, because the cable of an embodiment has an insulation formed from an ethylene copolymer having crystallinity between 1% and 30%, not including 30%, the insulation is not subject to deform even after crosslinking under a high temperature and high pressure atmosphere subsequently to extrusion of a sheath. However, because the cable of comparative examples has an insulation formed from a material having crystallinity of 30% or more, the insulation is severely deformed after crosslinking under a high temperature and high pressure atmosphere subsequently to extrusion of a sheath.

It is found from the results that the cable manufactured using the insulation resin composition resistant to thermal deformation according to an embodiment meets the standards for Shore A hardness at room temperature and modulus, and is free of deformation.

The cable manufactured by assembly of insulating electric wires formed using the insulation resin composition of an embodiment is resistant to thermal deformation that may occur after a crosslinking process under high temperature and high pressure subsequently to extrusion of a sheath.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An insulation resin composition resistant to thermal deformation, comprising:
a base resin comprising an ethylene copolymer having crystallinity less than 30%; and
0.5 to 20 parts by weight of an organic peroxide-based crosslinking agent per 100 parts by weight of the base resin.

2. The insulation resin composition resistant to thermal deformation according to claim 1, wherein the base resin comprises an ethylene copolymer having crystallinity between 1% and 30%, not including 30%.

3. An insulating electric wire, comprising a central conductor, coated with the insulation resin composition resistant to thermal deformation defined in claim 1.

4. A cable, comprising at least one of the insulating electric wire of claim 3.

5. The cable according to claim 4, wherein the insulation has a tensile strength of 12.5 N/m² or more and an elongation of 250% or more at room temperature, and a hardness of 90 or less using a Shore A hardness scale.

6. An insulating electric wire, comprising a central conductor, coated with the insulation resin composition resistant to thermal deformation defined in claim 2.

7. A cable, comprising at least one of the insulating electric wire of claim 6.

5. The cable according to claim 7, wherein the insulation has a tensile strength of 12.5 N/m² or more and an elongation of 250% or more at room temperature, and a hardness of 90 or less using a Shore A hardness scale.
